(19) United States
(12) Patent Application Publication
(10) Pub. No.: US 2006/0215225 A1
(43) Pub. Date: Sep. 28, 2006

(54) Print controller

(75) Inventor: Masahiro Murakami, Hekinan-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/384,373

(22) Filed: Mar. 21, 2006

(30) Foreign Application Priority Data
Mar. 24, 2005 (JP) 2005-086412

(51) Int. Cl. G06K 15/00

(52) U.S. Cl. 358/1.18; 358/1.2

(57) ABSTRACT

A print controller includes: a setting unit that sets, in a page on which an image is formed, a memo column as a space for writing a memo and an image area for forming the image; an image data generating unit that generates image data for forming the memo column and the image area as set by the setting unit; and an output unit that outputs the image data generated by the image data generating unit.

### CROSS REFERENCE TO RELATED APPLICATION

This application claims priority from Japanese Patent Application No. 2005-086412 filed on Mar. 24, 2005, the entire subject matter of which is incorporated herein by reference.

### TECHNICAL FIELD

The present invention may relate to a print controller for outputting print data to an image forming device, and may relate to a computer-readable program product for the print controller.

### BACKGROUND

In a copying machine, a technique is disclosed that a single recording sheet is divided into a plurality of areas to record images in the areas respectively and make a prescribed area blank (see JP-A-2002-232681). According to this technique, since a blank area can be formed on an original copy in which the images are formed by the copying machine, the blank area can be used as a memo column.

However, in the case of a printer connected to a personal computer (PC), some of specific software in the PC has a function for inserting the memo column when a formed image is printed. However, when the image is printed by using arbitrary software having no such function, the memo column has been hitherto hardly freely inserted.

Further, in the above-described related art, page numbers of forming images are different between a case that the blank area is provided and a case that the blank area is not provided. For instance, as shown in FIG. 10A, when one page is divided into two areas to record images in the areas respectively, if a blank area is not provided, a first image and a second image are formed on a first page and a third image and a fourth image are formed on a second page. As compared therewith, as shown in FIG. 10B, when the right side of the first page is used as a blank area, the second image is formed on the second page. Consequently, page numbers when the blank area is provided are shifted from those when the blank area is not provided. Thus, an image (an image having no blank area) formed by an application is different from an original copy on which the image is actually formed, so that a utility of a user is deteriorated.

### SUMMARY

One aspect of the present invention may provide a print controller and a program in which a memo column can be inserted into a medium on which an image is formed by an image forming device and the numbers of pages on which the images are formed are not shifted even when the memo column is inserted.

A print controller includes: a setting unit that sets, in a page on which an image is formed, a memo column as a space for writing a memo and an image area for forming the image; an image data generating unit that generates image data for forming the memo column and the image area as set by the setting unit; and an output unit that outputs the image data generated by the image data generating unit.

A computer-readable program product for causing a computer to perform procedures including: setting, in a page on which an image is formed, a memo column as a space for writing a memo and an image area for forming the image; generating image data for forming the memo column and the image area as set; and outputting the image data generated.

### BRIEF DESCRIPTION OF THE DRAWINGS

In the accompanying drawings:

FIG. 1 is a block diagram showing the structure of an image data processor;

FIG. 2 is a flowchart showing processes performed by a controller;

FIGS. 3A and 3B are explanatory views showing an arrangement of an image area and a memo column in a page;

FIG. 4 is a flowchart showing a layout printing process performed by the controller;

FIG. 5 is an explanatory view showing a print dialogue displayed on a display;

FIG. 6 is an explanatory view showing a setting screen displayed on the display;

FIG. 7 is an explanatory view showing a setting screen displayed on the display;

FIG. 8 is an explanatory view showing a setting screen displayed on the display;

FIGS. 9A and 9B are explanatory views showing an arrangement of an image area and a memo column in a page; and

FIGS. 10A and 10B are explanatory views showing the arrangement of images when a memo column is inserted into a page in a related art.

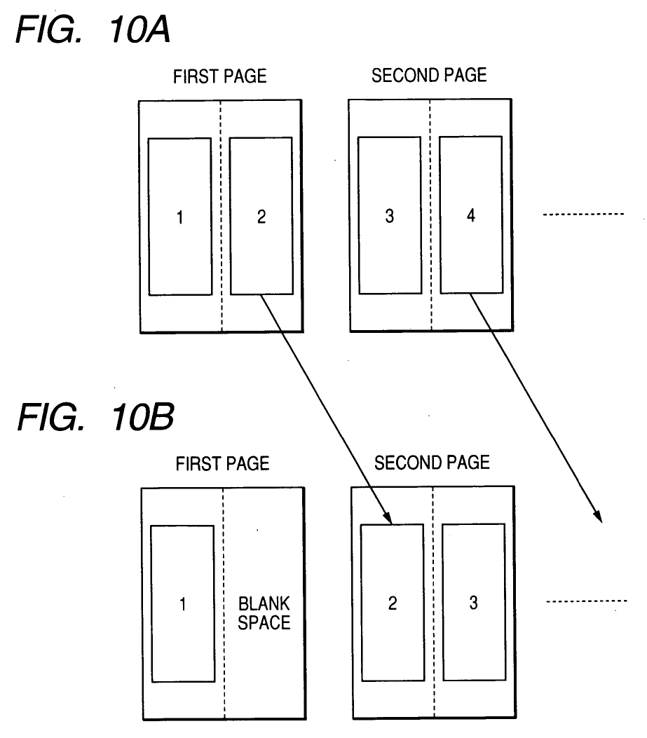

### DETAILED DESCRIPTION

Illustrative aspects of the present invention will be described hereinbelow by reference to the drawings.

First illustrative aspect

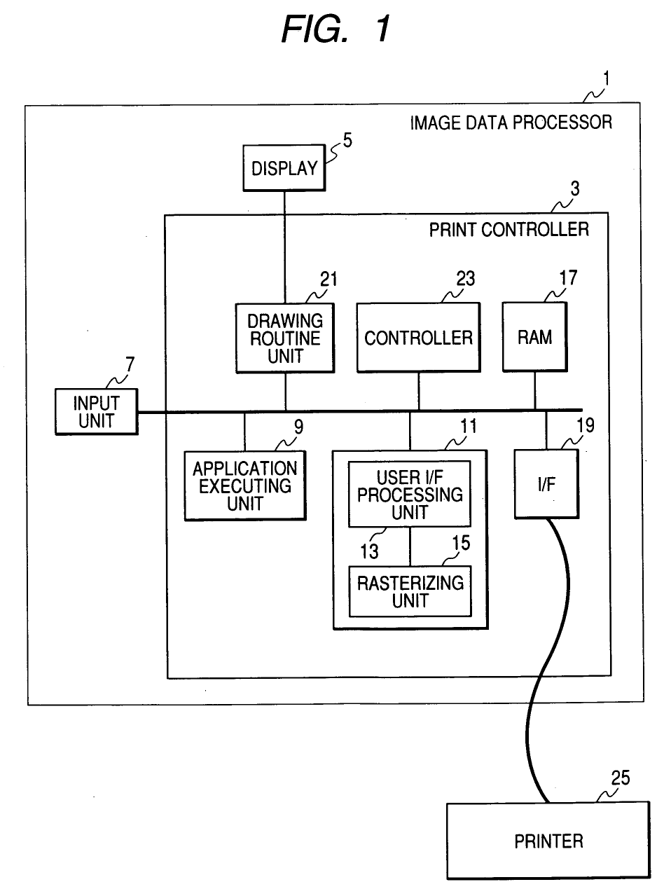

A configuration of an image data processor 1 as a first illustrative aspect for a print controller will be described with reference to FIG. 1.

The image data processor 1 includes a print controller 3, a display 5 and an input unit 7 and is connected to a printer 25.

The print controller 3 includes an application executing unit 9, a driver unit 11, a RAM 17, an interface unit 19, an drawing routine unit 21 and a controller 23.

The application executing unit 9 executes a prescribed program for generating image data and instructs the driver unit 11 to perform a printing operation.

The driver unit 11 includes a user interface processing unit 13 and a rasterizing unit 15 and serves as a setting unit. That is, the user interface processing unit 13 receives from the display 5 a designation about the position and the size of a memo column on a page of a medium printed by the printer 25 and the kind of a display shown on the memo column and the rasterizing unit 15 sets the memo column as a space for a memo and an image area for forming an image in the page in accordance with the designation.

Further, the driver unit 11 also functions as an image data generating unit. That is, the rasterizing unit 15 forms image of the entire part of the page in which the memo column and the image area are arranged and stores the image data in the RAM 17. In the image data of all the pages, the image data generated by the application executing unit 9 is scaled up or scaled down and accommodated in the image area while the aspect ratio thereof is maintained. Further, in accordance with a designation sent to the user interface processing unit 13 from the display 5, the description of characters of the “memo column”, a frame by which the periphery of the memo column is surrounded and a rule in the memo column are added to the memo column.

The RAM 17 stores the image data transmitted from the driver unit 11. The image data stored in the RAM 17 designates, when the page in which the memo column is inserted is printed, the image data of the entire part of the page in which the memo column and the image area formed by the driver unit 11 are arranged. On the other hand, when the memo column is not inserted into the page, the memo column is not included in the image data.

The interface unit 19 functions as an output unit and outputs the image data stored in the RAM 17 to the printer 25 under the control of the controller 23.

The drawing routine unit 21 processes various kinds of image data such as the image data stored in the RAM 17 to display the image data on the display 5.

The controller 23 controls the operations of each units of the print controller 3. Further, the controller 23 also controls the interface unit 19 to output the image data generated by the driver unit 11.

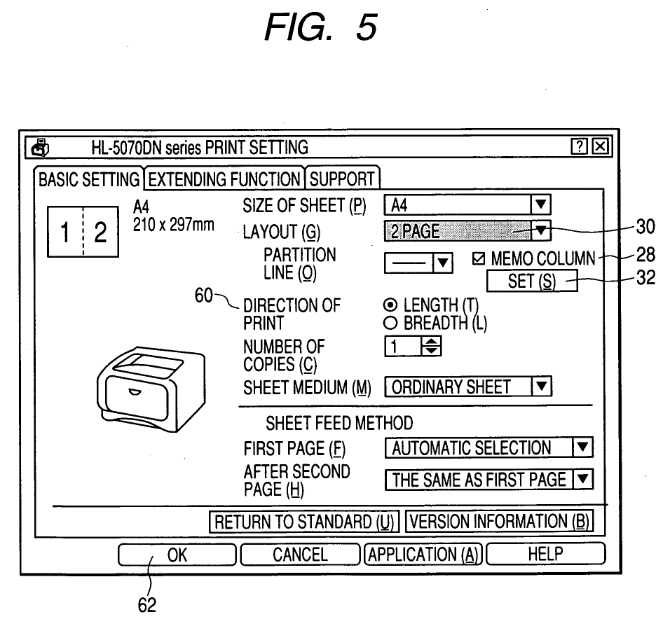

The display 5 has a display screen configured by an LCD, a CRT, and the like, and displays setting screens shown in FIGS. 5 to 8. Further, the display 5 also serves as a designating unit and a display unit. Namely, when a user carries out operations such as pushing down buttons of the setting screens shown in FIGS. 5 to 8 or marking the check boxes, the display 5 displays and allows the user to designate the position and the size of the memo column and the kind of a notation that denotes the memo column in the memo column, in the page to be printed in accordance with the operations. Further, the display 5 designates the number of image areas provided in the page to be printed. Still further, the display 5 displays the messages of executed processes or processes that are being now executed to the user.

The input unit 7 is an input device such as a mouse, a keyboard or the like. The user uses the input unit 7 to carry out the operations such as pushing down the buttons of the setting screen displayed in the display 5 or marking the check boxes.

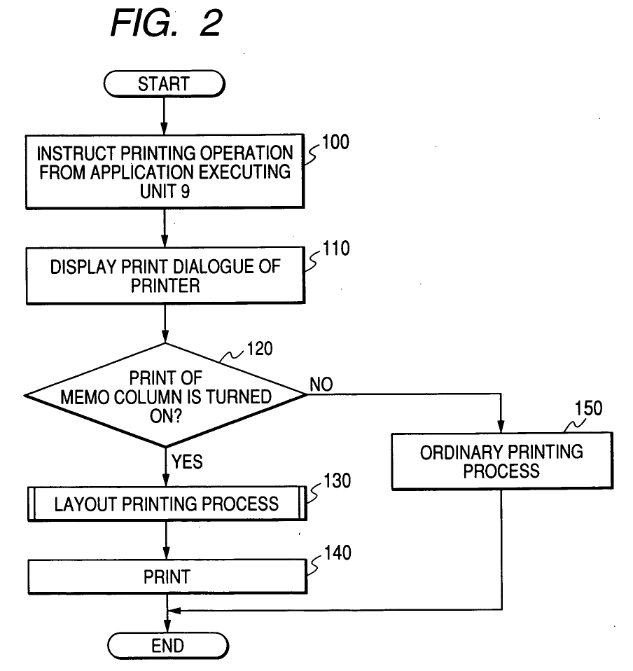

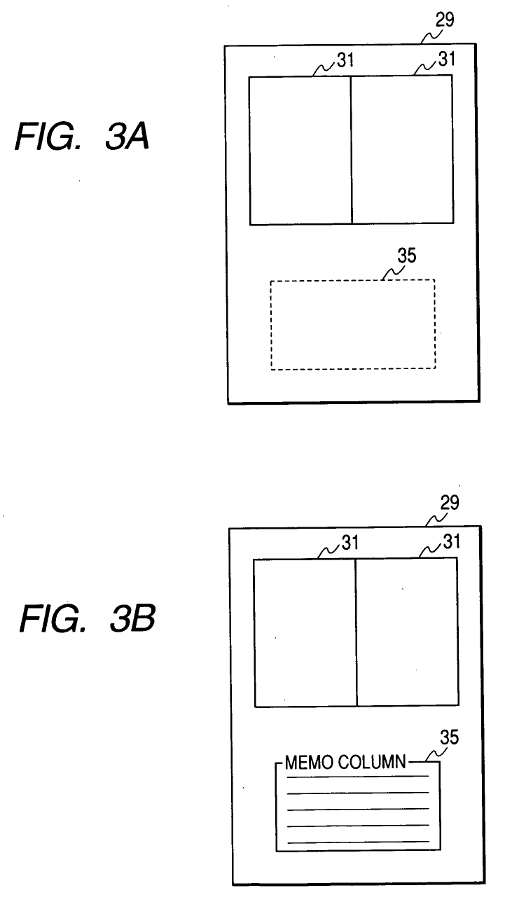

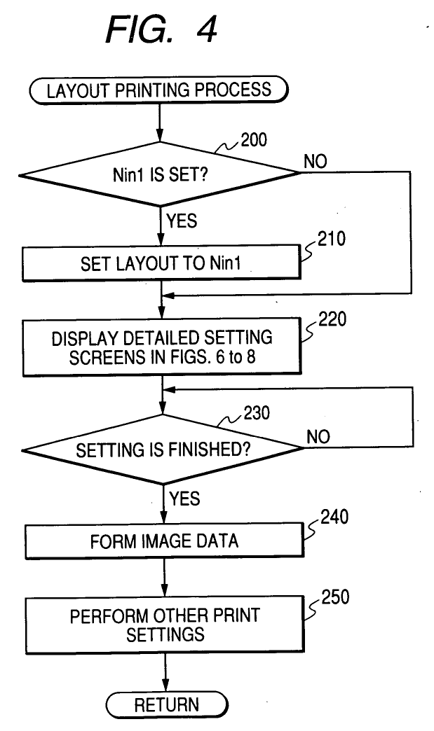

Subsequently, processes performed by the controller 23 of the image data processor 1 will be described with reference to flowcharts shown in FIGS. 2 and 4 and explanatory views shown in FIGS. 3A and 3B, and FIGS. 5-8.

When the user employs the application to perform a printing operation of an image, the controller controls the application executing unit 9 to instruct the driver unit 11 to print the image and controls the RAM 17 to store the image data and advances to step 110 (step 100 in FIG. 2).

Then, when the user performs a prescribed operation to the input unit 7, the controller controls the display 5 to display a print dialogue of the printer shown in FIG. 5 to the user interface processing unit 13 of the driver unit 11 through the drawing routine unit 21 (step 110). In the print dialogue, the user can perform various kinds of settings on a printing such as a “layout” pull-down menu 30, the direction of a print 60, etc.

In step 120, in the displayed print dialogue, the controller decides whether or not the print of the memo column is turned on. That is, in the print dialogue shown in FIG. 5, when the user checks a “memo column” check box 28 and presses a button of a “setting” 32, the controller decides that the print of the memo column is turned on (YES). On the other hand, when the user does not check the “memo column” 28 and presses a button of “OK” 62, the controller decides that the print of the memo column is not turned on (NO). In the case of YES, the controller advances to step 130. In the case of NO, the controller advances to step 150.

In the step 130, the controller controls the driver unit 11 to perform a layout printing process. The layout printing process will be described with reference to the flowchart shown in FIG. 4.

Initially, in a setting dialogue shown in FIG. 5, the controller decides whether or not the user sets the column of the “layout” pull-down menu 30 to N pages (namely, whether or not the user sets the column of the layout to a layout of Nin1, or of a N-up) (step 200). In the case of YES, the controller advances to step 210. In the case of NO, the controller advances to step 220. In FIG. 5, the column of the “layout” pull-down menu 30 is set to 2 pages. However, the set value is not limited to two pages, and the set value may be one page or three or more pages.

In step 210, the controller controls the driver unit 11 to set the layout of a page to the Nin1.

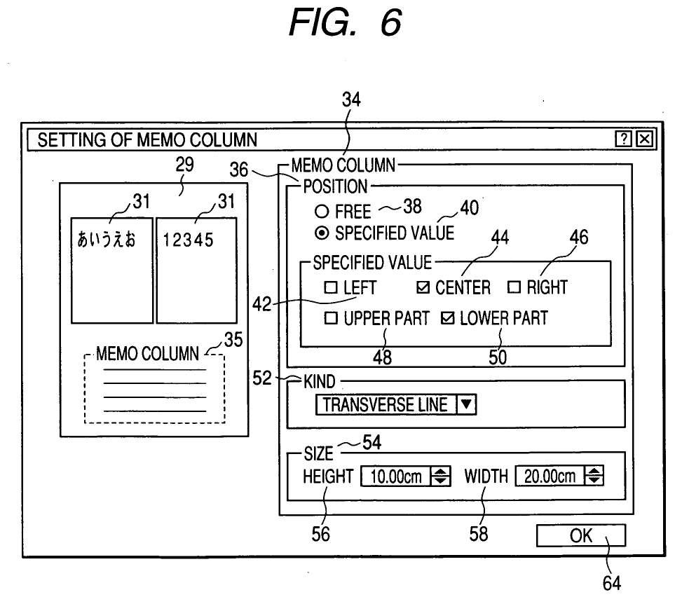

In step 220, the controller controls the driver unit 11 to display a setting dialogue of a memo column as shown in FIG. 6 on the display unit 5. The setting dialogue displays items (position, kind, size) on the setting of the memo column in a right side and image areas 31 and the layout of the memo column 35 on a “page” 29 in a left side. This layout corresponds to the setting of the right side of the setting dialogue and is updated when the setting is changed.

The user sets the position of the memo column 35 on the page 29 in accordance with the setting in a position 36 in a memo column 34. Specifically, when the user selects a free 38, the user can freely set the position of the memo column 35 in the page 29 by the input unit 7. On the other hand, when the user selects a specified value 40, the user selects any of a left 42, a center 44, a right 46, an upper part 48 ands a lower part 50 located below the specified value 40. In this case, the position of the memo column 35 is set to a specified position corresponding to any position selected from the left 42, the center 44, the right 46, the upper part 48 and the lower part 50.

Further, the user sets a rule displayed in the memo column 35 in a column of a kind 52. In the “kind” pull-down menu 52, the user can select one from many kinds of settings for lines including a horizontal line, a vertical line, no lines, etc.

Further, the user can set the height and width of the memo column in a “size” text box 54. Specifically, the user can set the height and the width of the memo column by inputting the numerical value of the height of the memo column 35 to the “height” column 56 and the numerical value of the width of the memo column 35 to the “width” text box 58.

The position of the memo column 35, the kind of the rule drawn in the memo column 35 and the size of the memo column 35 set in the setting dialogue shown in FIG. 6 are transmitted to the driver unit 11 from the display 5 as an instruction.

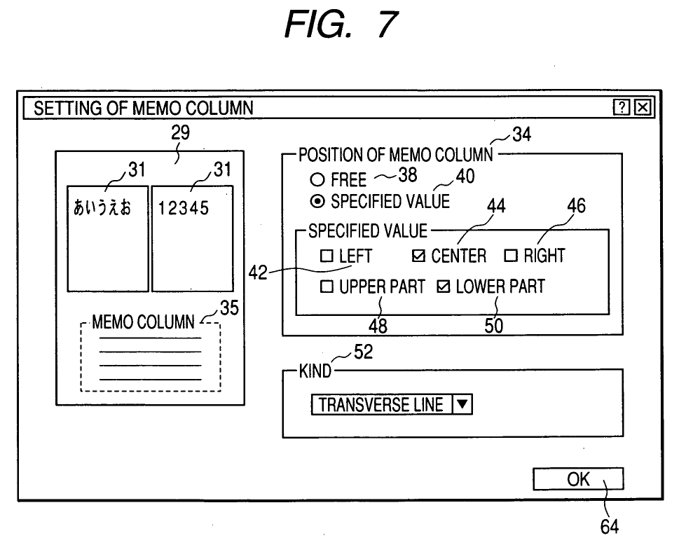

The setting dialogue shown in FIG. 6 serves to set the position of the memo column 35, the kind of the rule drawn in the memo column 35 and the size of the memo column 35, however, the setting dialogue may set only a part of these items. For instance, as shown in FIG. 7, the setting dialogue may set a position of the memo column 35 and a kind of a rule drawn in the memo column 35. In this case, the size of the memo column 35 is set to a specified value.

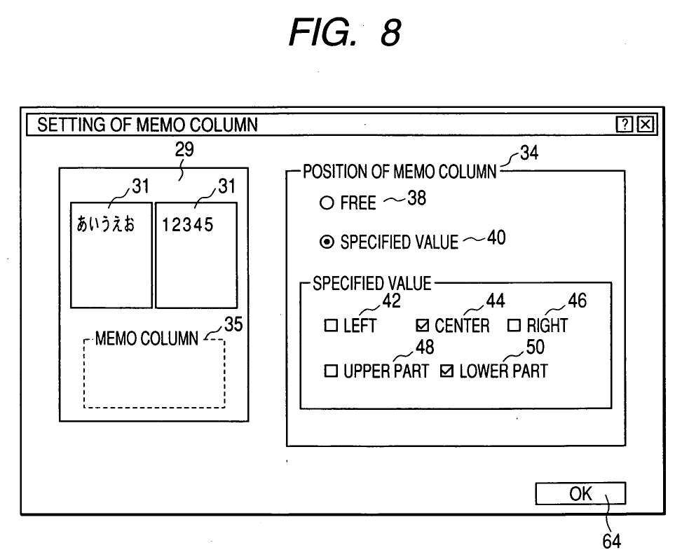

Further, as shown in FIG. 8, the setting dialogue may set only the position of the memo column 35. In this case, the kind of a rule drawn in the memo column 35 and the size of the memo column 35 are set to specified values.

In step 230, the controller decides whether or not the setting of the layout printing process is completed. Specifically, the controller decides whether or not the setting of the memo column by the user is finished in the setting dialogue shown in FIG. 6 (or FIGS. 7 to 8) in accordance with whether or not an OK button 64 is pressed. In the case of YES, the controller 23 advances to step 240. In the case of NO, the controller returns to the step 230.

In the step 240, the driver unit 11 sets an arrangement so that the memo column 35 and the image areas 31 can be formed on the page 29 of a medium printed by the printer 25 as shown in FIG. 3A. The position, the size and the kind of the memo column 35 in this arrangement are set by the driver 11 on the basis of the results inputted to the setting dialogue shown in FIG. 6 by the user.

Further, the number of the image areas 31 arranged in the page 29 is set by the driver 11 on the basis of the value inputted to the column of the “layout” pull-down menu 30 in the setting screen shown in FIG. 5. For instance, in the case of what is called a 2in1 that a value inputted to the column of the “layout” pull-down menu 30 is “2”, two image areas 31 are set as shown in FIG. 3A. The number of the image areas 31 is not limited to 2 and may be set to 1 or 3 or more.

Further, the driver 11 is instructed to scale up or scale down and fit the image data generated by the application executing unit 9 in the image areas 31 while maintaining the aspect ratio thereof. Then, the driver unit 11 is controlled to form the image data of the entire part of the page in which the memo column and the image areas are arranged as described above and the RAM 17 is controlled to store the image data.

In step 250, the controller controls the driver 11 to perform other print settings (for instance, size of a sheet, a partition line, a direction of a print, number of sets, a sheet medium, a sheet feed method, etc.) on the basis of the setting of the user in the print dialogue shown in FIG. 5. After this step is completed, the controller advances to step 140 in the flowchart shown in FIG. 2.

In the step 140, the controller controls the driver unit 11 to instruct the printer 25 to output the image data stored in the RAM 17 through the interface unit 19 and print.

On the other hand, in the step 120, when the controller decides NO, the controller advances to step 150 and performs a process for controlling the driver 11 to carry out an ordinary printing operation (a printing operation without inserting a memo column).

Now, advantages obtained by the image data processor 1 of the first illustrative aspect and the driver unit 11 will be described below.

When the memo column is inserted into the page, the image data processor 1 of the first illustrative aspect sets the image areas 31 and the memo column 35 in the page 29 as shown in FIGS. 6 to 8 to form images in the image areas 31 therein.

At this time, the number of the image areas 31 provided in the page 29 is equal to the number set in the column of the “layout” pull-down menu 30 (see FIG. 5) of the print dialogue. Accordingly, even when the memo column 35 is inserted into the page 29, the number of the images provided in the page 29 is fixed. Therefore, a phenomenon does not arise, as in the related art, that when the memo column is inserted into the page, page numbers in which the images are formed are shifted.

In the first illustrative aspect, since the driver unit 11 scales up or scales down and accommodates the image data generated by the application executing unit 9 in the image area while the driver unit maintains the aspect ratio of the image data, the image is not distorted. Further, the image data is scaled up or scaled down, so that the size of the image can be adapted to the image area.

In the first illustrative aspect, the driver unit 11 generates the image data of the entire part of the page in which the memo column and the image areas are arranged to record the image data in the RAM 17 and the interface unit 19 outputs the image data to the printer 25. Accordingly, the printer 25 side does not need to form the image data of the entire part of the page as described above and may merely form the image in accordance with the image data transmitted from the image data processor 1. Thus, a burden of processing for the printer 25 can be reduced.

In the image data processor 1 of the first illustrative aspect, even when the arrangement of the images on the page is set to the Nin1, the memo column can be provided without shifting the page numbers.

In the image data processor 1 of the first illustrative aspect, the position and the size of the memo column and the display in the memo column can be designated in accordance with results inputted to the display unit 5 from the input unit 7 by the user. As a result, the user interface can be provided that has a high degree of freedom for the arrangement of the page.

Second illustrative aspect

An image data processor 1 of a second illustrative aspect is basically the same as the first illustrative aspect in view of its structure or operation, however, partly different from the first illustrative aspect. Now, the difference will be mainly described below.

In the image data processor 1 of the second illustrative aspect, when the arrangement of a page on which a memo column is to be set designates a portrait, the memo column is arranged in a lower side of the page. Specifically, when a user tries to print the page into which the memo column is inserted, the user sets the direction 60 of a sheet to lengthwise in the print dialogue shown in FIG. 5, the position of the memo column 35 is automatically set to a “lower part” in the setting screens shown in FIGS. 6 to 8.

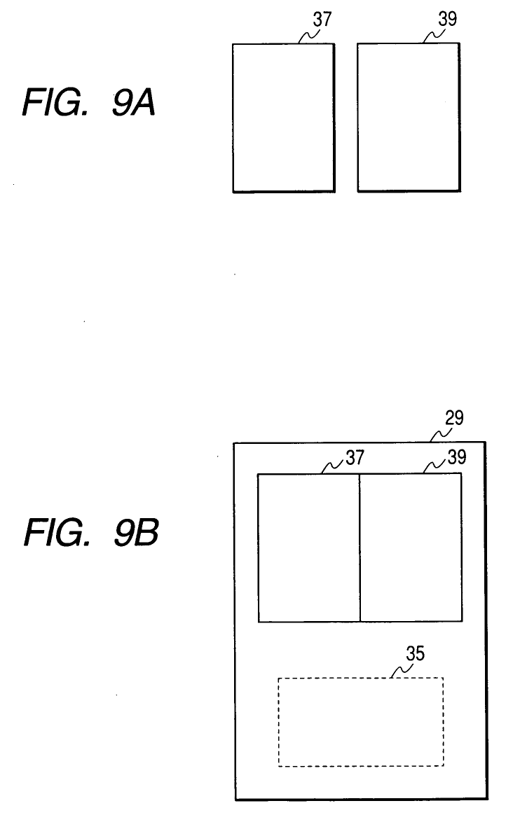

Consequently, when image data generated by an application executing unit 9 is arranged on the page, the image data does not need to be rotated relative to the page. The above-described matter will be specifically described with reference to FIGS. 9A and 9B. As shown in FIG. 9A, when longitudinal image areas 37 and 39 in which the image data generated by the application executing unit 9 is arranged are horizontally disposed in the longitudinal page 29 to set the arrangement of images to 2in1 and the arrangement of the page 29 is set to a portrait, that is, when the image areas of Nin1 are set on the longitudinal page 29 of the portrait, if the memo column 35 is provided in the lower side of the image areas 37 and 39 on the page 29 as shown in FIG. 9B, a rotating process may not be applied to the image data arranged in the image areas 37 and 39 located above the memo column and the image data can be accommodated in the page 29 with a large size as much as possible. Accordingly, since the image data processor 1 does not need to perform a process for rotating the image data relative to the page, burdens of processing for the image data processor 1 and a printer 25 can be reduced.

The present invention is not limited to the above-described illustrative aspects and it is to be understood that the present invention may be embodied in various forms that fall within a scope and spirit of the present invention.

For instance, in the above-described first and second illustrative aspect, the RAM for storing the image data of the entire part of the page in which the memo column and the image areas are arranged may be provided in the printer 25. That is, the image data processor 1 may transmit the image data (including no memo column) formed by the application executing unit 9 and an instruction on the arrangement of the memo column to the printer 25 and the printer 25 side may form the image data of the entire part of the page in which the memo column and the image areas are arranged to store the image data in the RAM of the printer 25 side.

Further, in the above-described first and second illustrative aspect, the image areas may be provided on a front surface of a medium of the printer 25 and the memo column may be on a back surface of the same medium. In this case, to the memo column, a display can be attached for indicating the memo column (for instance, characters of the “memo column” are written in the vicinity or in the inner part of the memo column, the periphery of the memo column is surrounded by a frame or a rule is drawn in the memo column).

As described above in detail with reference to the illustrative aspects, there is provided the following configurations.

(1) A print controller including: a setting unit that sets, in a page on which an image is formed, a memo column as a space for writing a memo and an image area for forming the image; an image data generating unit that generates image data for forming the memo column and the image area as set by the setting unit; and an output unit that outputs the image data generated by the image data generating unit.

According to the configuration of (1), the image area and the memo column are set on a single page and the image to be originally formed on the page is formed in the image area. Therefore, according to the present invention, even when the memo column is provided, the image is formed on the same page as the page when the memo column is not provided. That is, a phenomenon does not arise that when the memo column is inserted, the number of the page on which the image is formed is shifted as in the related art.

(2) In the print controller of (1), the setting unit may be configured to scale the image to fit the image in the image area while maintaining aspect ratio of the image.

According to the print controller of (2), since the aspect ratio of the image is maintained, even when the image is scaled up or scaled down, the image is not distorted. Further, since the image is scaled up or scaled down, the size of the image can be adapted to the image area.

(3) In the print controller of (1), the image data generating unit may be configured to generate the image data as the image data of the entire part of the page in which the memo column and the image area are arranged.

According to the print controller of (3), the image data generating unit generates the image data of the entire part of the page in which the memo column and the image area are arranged and the output unit outputs the image data. Accordingly, the image forming device side does not need to form the above-described image data and may merely form the image in accordance with the transmitted image data. Thus, a burden of processing for the image forming device can be reduced.

(4) In the print controller of (1), the setting unit may be configured to set a plurality of pages in a Nin1 arrangement, where N is an integer not smaller than 2, in the image area by scaling down the images of the pages that are previously generated by an application program.

According to the print controller of (4), even when the images in the page are arranged in accordance with the arrangement of the Nin1, page numbers are not shifted and the memo column can be provided. Herein, the phrase “Nin1 arrangement” means that N images (or original pages) are arranged on one page.

(5) In the print controller of (4), the setting unit may be configured to set the memo column in a lower portion of the page that is to be printed in a portrait direction with the image area being set in the Nin1 arrangement.

According to the print controller of (5), when the arrangement of the Nin1 is set on the page of the portrait, the memo column is arranged in the lower side of the image area in the page. Accordingly, even when the memo column is provided, the image is not rotated relative to the page. Thus, burdens of processing for the print controller and the image forming device can be reduced.

(6) The print controller of (1) may be configured to further include a designating unit that designates arrangements of the memo column and the image area on the page set by the setting unit.

According to the print controller of (6), the designating unit can designate the arrangements of the memo column and the image area in accordance with results inputted from, for instance, a mouse or a keyboard by a user. Thus, a user interface having a high degree of freedom on the arrangement of the pages can be provided.

(7) In the print controller of (6), the designating unit may be configured to designate a position of the memo column in the page.

According to the print controller of (7), the designating unit can designate the position of the memo column in accordance with results inputted from, for instance, the mouse or the keyboard by the user. Thus, the user interface having a high degree of freedom on the position of the memo column can be provided.

(8) In the print controller of (6), the designating unit may be configured to designate a size of the memo column.

According to the print controller of (8), the designating unit can designate the size of the memo column in accordance with results inputted from, for instance, the mouse or the keyboard by the user. Thus, the user interface having a high degree of freedom on the size of the memo column can be provided.

(9) The print controller of (1) may be configured to further include a display unit for displaying a notation in the memo column, the notation that denotes the memo column.

According to the configuration of (9), since a display showing the memo column is provided in the memo column, the memo column can be more clarified. The memo column may be displayed on the back surface of a medium by a perfect printing operation.

(10) There is also provided a computer-readable program product for causing a computer to perform procedures including: setting, in a page on which an image is formed, a memo column as a space for writing a memo and an image area for forming the image; generating image data for forming the memo column and the image area as set; and outputting the image data generated.

(11) The program product of (10) may be configured that, in setting the memo column and the image area, the image is scaled to fit the image in the image area while maintaining aspect ratio of the image.

(12) The program product of (10) may be configured that, in generating the image data, the image data is generated as the image data of the entire part of the gape in which the memo column and the image area are arranged.

(13) The program product of (10) may be configured that, in setting the memo column and the image data, a plurality of pages are set in a Nin1 arrangement, where N is an integer not smaller than 2, in the image area by scaling down the images of the pages that are previously generated by an application program.

(14) The program product of (13) may be configured that, in setting the memo column and the image data, the memo column is set in a lower portion of the page that is to be printed in a portrait direction with the image area being set in the Nin1 arrangement.

(15) The program product of (10) may be configured to cause the computer to perform procedures further including designating arrangements of the memo column and the image area on the page.

(16) The program product of (15) may be configured that, in designating the arrangements, a position of the memo column in the page is designated.

(17) The program product of (15) may be configured that, in designating the arrangements, a size of the memo column is designated.

(18) The program product of (10) may be configured to cause the computer to perform procedures further including displaying a notation in the memo column, the notation that denotes the memo column.

According to the configurations of (10)-(18), the advantages as those obtained by the configurations of (1)-(9) can be obtained.

(19) The program product of (10) may be configured that, the program product is configured as a printer driver.

According to the configuration of (19), the image data generated by various applications is received and the memo column can be provided in a prescribed page in the image data without shifting the page numbers to which the images respectively belong.

The foregoing description of the illustrative aspects have been presented for purposes of illustration and description. It is not intended to be exhaustive or to limit the invention to the precise form disclosed, and modifications and variations are possible in light of the above teachings or may be acquired from practice of the invention. The illustrative aspects were chosen and described in order to explain the principles of the invention and its practical application program to enable one skilled in the art to utilize the invention in various illustrative aspects and with various modifications as are suited to the particular use contemplated. It is intended that the scope of the invention be defined by the claims appended hereto, and their equivalents.

What is claimed is:

1. A print controller comprising:
a setting unit that sets, in a page on which an image is formed, a memo column as a space for writing a memo and an image area for forming the image;
an image data generating unit that generates image data for forming the memo column and the image area as set by the setting unit; and
an output unit that outputs the image data generated by the image data generating unit.

2. The print controller according to claim 1, wherein the setting unit scales the image to fit the image in the image area while maintaining aspect ratio of the image.

3. The print controller according to claim 1, wherein the image data generating unit generates the image data as the image data of the entire part of the page in which the memo column and the image area are arranged.

4. The print controller according to claim 1, wherein the setting unit sets a plurality of pages in a Nin1 arrangement, where N is an integer not smaller than 2, in the image area by scaling down the images of the pages that are previously generated by an application program.

5. The print controller according to claim 4, wherein the setting unit sets the memo column in a lower portion of the page that is to be printed in a portrait direction with the image area being set in the Nin1 arrangement.

6. The print controller according to claim 1, further comprising a designating unit that designates arrangements of the memo column and the image area on the page set by the setting unit.

7. The print controller according to claim 6, wherein the designating unit designates a position of the memo column in the page.

8. The print controller according to claim 6, wherein the designating unit designates a size of the memo column.

9. The print controller according to claim 1, further comprising a display unit for displaying a notation in the memo column, the notation that denotes the memo column.

10. A computer-readable program product for causing a computer to perform procedures comprising:
setting, in a page on which an image is formed, a memo column as a space for writing a memo and an image area for forming the image;
generating the image data for forming the memo column and the image area as set; and
outputting the image data generated.

11. The program product according to claim 10, wherein in setting the memo column and the image area, the image is scaled to fit the image in the image area while maintaining aspect ratio of the image.

12. The program product according to claim 10, wherein in generating the image data, the image data is generated as the image data of the entire part of the gape in which the memo column and the image area are arranged.

13. The program product according to claim 10, wherein in setting the memo column and the image data, a plurality of pages are set in a Nin1 arrangement, where N is an integer not smaller than 2, in the image area by scaling down the images of the pages that are previously generated by an application program.

14. The program product according to claim 13, wherein in setting the memo column and the image data, the memo column is set in a lower portion of the page that is to be printed in a portrait direction with the image area being set in the Nin1 arrangement.

15. The program product according to claim 10, causing the computer to perform procedures further comprising designating arrangements of the memo column and the image area on the page.

16. The program product according to claim 15, wherein in designating the arrangements, a position of the memo column in the page is designated.

17. The program product according to claim 15, wherein in designating the arrangements, a size of the memo column is designated.

18. The program product according to claim 10, causing the computer to perform procedures further comprising displaying a notation in the memo column, the notation that denotes the memo column.

19. The program product according to claim 10, wherein the program product is configured as a printer driver.
